(19) United States
(12) Patent Application Publication
(10) Pub. No.: US 2024/0029940 A1
(43) Pub. Date: Jan. 25, 2024

(54) MAGNETIC ELEMENT AND MANUFACTURING METHOD THEREOF

(71) Applicant: Delta Electronics (Shanghai) Co., Ltd., Shanghai (CN)

(72) Inventors: Debao Quan, Shanghai (CN); Jiamin Shi, Shanghai (CN); Haijun Yang, Shanghai (CN)

(21) Appl. No.: 18/220,798

(22) Filed: Jul. 11, 2023

(30) Foreign Application Priority Data
Jul. 21, 2022 (CN) 202210864014.2

(51) Int. Cl. H01F 27/26; H01F 27/22; H01F 17/06; H01F 41/02; H01F 27/30

(52) U.S. Cl. CPC H01F 27/263; H01F 27/22; H01F 17/062; H01F 41/0206; H01F 27/306

(57) ABSTRACT

The present disclosure provides a magnetic element and a manufacturing method thereof. The manufacturing method including steps of: (a) dividing a magnetic core into a first component and a second component, wherein the first and second components have two connecting surfaces on the split section respectively, and the first and second components have an inner and an outer surfaces; (b) disposing a flexible material on the inner surfaces of the first and second components respectively; (c) sleeving a coil on the first and second components; (d) connecting the two connecting surfaces of the first component to the two connecting surfaces of the second component to assemble the first and second components; (e) utilizing a thermal conduction glue to pot the magnetic element; and (f) curing and forming the thermal conduction glue after a curing time.

### CROSS-REFERENCE TO RELATED APPLICATION

This application claims priority to China Patent Application No. 202210864014.2, filed on Jul. 21, 2022, the entire contents of which are incorporated herein by reference for all purposes.

### FIELD OF THE INVENTION

The present disclosure relates to a magnetic element and a manufacturing method thereof, and more particularly to an inductor element and a manufacturing method thereof.

### BACKGROUND OF THE INVENTION

With the development of the switching power supply technology, power inductors are usually required for the power supply system with large power. However, due to the gradual increase in labor costs, the coils of inductors have been developed to be produced by machine rather than manual winding. Edgewise coils are widely used in the power supply system.

When the amount of turns of the edgewise coil is small, the coil can be wound directly on the magnetic core by machine. However, when the amount of turns of the edgewise coil is large and the space requirement for coils is strict, the coil cannot be wound directly on the magnetic core.

The manufacturing methods of the magnetic element with edgewise coil known by the inventor are as following approaches. In the first approach, the magnetic core is divided into two approximately equal parts, and after the prefabricated coil is sleeved on the magnetic core, the two parts of the magnetic core are fixed by ties (usually by metal material) with a buckle and adhesive glue. However, the fixing way utilizing the metal ties has problems such as magnetic core offset and manual operation required, which reduces the production efficiency. In addition, the buckle of the metal tie has a large volume, so the buckle may occupy the filling space of the coil, resulting in a low filling rate of the coil, thereby limiting the inductance of the magnetic element. In the second approach, the magnetic core is divided into two parts, wherein one part is large one and the other part is small one. After the coil is sleeved on the magnetic core, the cross-sections of the larger part of the magnetic core and the smaller part of the magnetic core are then securely connected by the adhesive glue. However, in this approach, a gap may be easily formed at the contact surfaces of two parts of the magnetic core, resulting in a decrease in the inductance of the magnetic element. In addition, in order to ensure that the smaller part of the magnetic core can be accommodated in the breach of the larger part of the magnetic core, the coil cannot be disposed in the breach when assembly the small part into the breach, which also leads to a decrease in the coil filling rate. In the third approach, the magnetic core is divided into two approximately equal parts. After the coil is sleeved on the magnetic core, the cross-sections of the two parts of the magnetic core are securely connected by the adhesive glue and encapsulated by potting directly. The coil of the magnetic element is heated up during operation, the thermal conductive glue and the coil exert an expansion force on the magnetic core due to the thermal expansion. The glue-filled magnetic element manufactured by the third approach cannot avoid the risk of core cracking caused by the expansion of the thermal conductive glue between the coil and the magnetic core due to the heating of the coil and core during operation.

Therefore, there is a need of providing a magnetic element and a manufacturing method thereof to obviate the drawbacks encountered from the prior arts.

### SUMMARY OF THE INVENTION

It is an object of the present disclosure to provide a magnetic element and a manufacturing method thereof. The magnetic core is divided into two components, and before the two components are assembled to form a magnetic element, a flexible material with deformable property is disposed on the inner surface of each component. Therefore, during the operation of the potting magnetic element, when the thermal conduction glue between the coil and the magnetic core expands due to the heating generated by the coil and core, thus dilate the magnetic core, the flexible material can buffer the deformation of the thermal conduction glue and absorb the expansion force from the thermal conduction glue applied to the magnetic core, so as to avoid the deformation of the thermal conduction glue from affecting the connection of the two components. Meanwhile, there is no need to install additional metal ties or lose part of the available magnetic core winding space for accommodating the small part magnetic core, so the coil filling rate of the magnetic element, the inductance of the magnetic element, and the production efficiency is improved.

In accordance with an aspect of the present disclosure, there is provided a magnetic element. The magnetic element includes a first and a second components, a flexible material and a coil. The first and second components form a magnetic core with a hollow, each of the first component and the second component has two connecting surfaces on the split section, and each of the first component and the second component has an inner surface and an outer surface relative to a center of the magnetic core. The flexible material is disposed on each inner surface of the first component and the second component individually, wherein the flexible material has deformable property. The coil is sleeved on both of the first and second components. The two connecting surfaces of the first component are connected to the two connecting surfaces of the second component respectively to assemble the first and second components. The magnetic element is potted with a thermal conduction glue, wherein the flexible material is located between both of the inner surfaces of the first component and the second component and the thermal conduction glue within the hollow.

In accordance with an aspect of the present disclosure, there is provided a manufacturing method of a magnetic element. The manufacturing method of a magnetic element including steps of: (a) dividing a magnetic core having a hollow part into a first component and a second component, wherein each of the first component and the second component has two connecting surfaces of the split section, and each of the first component and the second component has an inner surface and an outer surface relative to a center of the magnetic core; (b) disposing a flexible material on each inner surface of the first component and the second component individually, wherein the flexible material has deformable property; (c) sleeving a coil on the first component and the second component; (d) connecting the two connecting surfaces of the first component to the two connecting surfaces of the second component to assemble the first and second components, wherein the magnetic core and the coil form a magnetic element; (e) potting the magnetic element with a thermal conduction glue, wherein at least a part of the flexible material is located between both of the inner surfaces of the first component and the second component and the thermal conduction glue within the hollow; and (f) curing and forming the thermal conduction glue after a curing time.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a magnetic element according to an embodiment of the present disclosure;

FIG. 2 is an exploded view of the magnetic element of FIG. 1;

FIG. 3 is a schematic perspective view illustrating the magnetic core of FIG. 1;

FIG. 4 is a schematic cross-sectional view illustrating the magnetic element of FIG. 1 after potting with the thermal conduction glue and taken along the cross-section XX;

FIG. 5 is a schematic cross-sectional view illustrating the magnetic element of FIG. 1 after potting with the thermal conduction glue and taken along the cross-section YY;

FIG. 6 is a schematic perspective view illustrating a magnetic element disposed in the device according to another embodiment of the present disclosure; and

FIG. 7 is a schematic flow chart illustrating a manufacturing method of the magnetic element according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

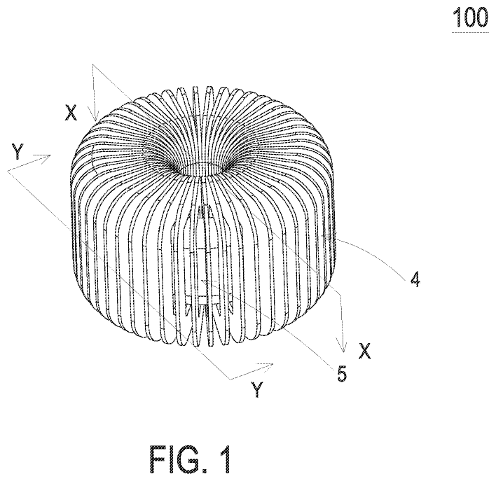

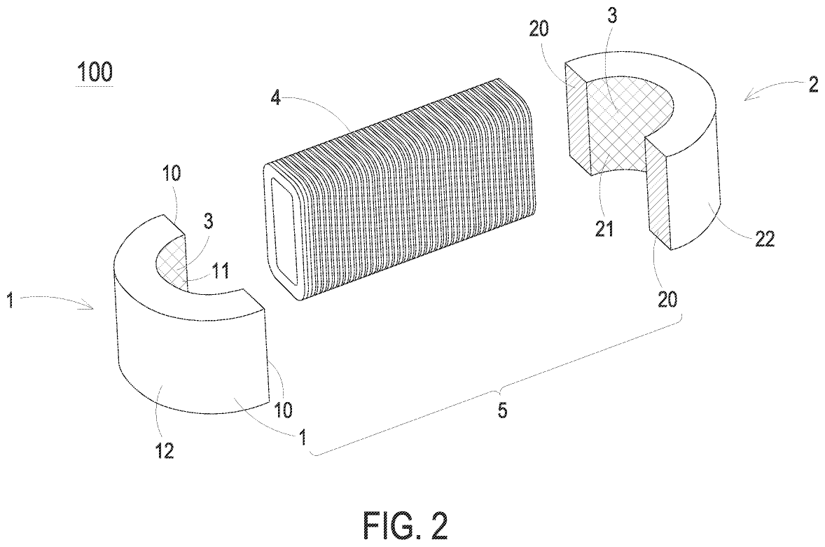

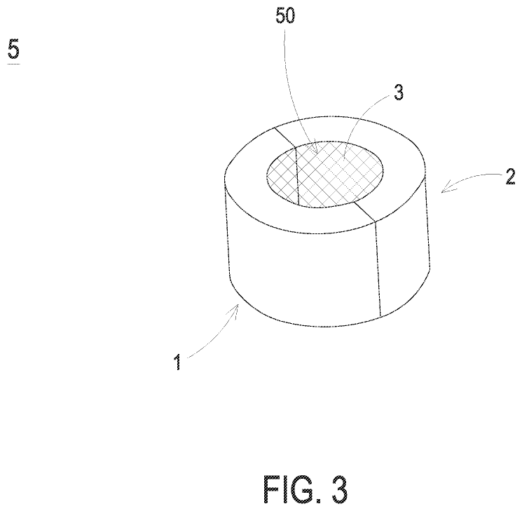

FIG. 1 is a schematic perspective view illustrating a magnetic element according to an embodiment of the present disclosure. FIG. 2 is an exploded view of the magnetic element of FIG. 1. FIG. 3 is a schematic perspective view illustrating the magnetic core of FIG. 1. As shown in FIGS. 1, 2 and 3, the magnetic element 100 of the present disclosure includes a first component 1, a second component 2, a flexible material 3 and a coil 4. The first component 1 and the second component 2 form a magnetic core 5 with a hollow 50, and the magnetic core 5 is for example but not limited to be a toroidal magnetic core. The first component 1 has two connecting surfaces 10, and the second component 2 has two connecting surfaces 20. The first component 1 has an inner surface 11 and an outer surface 12 relative to a center of the magnetic core 5. The second component 2 has an inner surface 21 and an outer surface 22 relative to the center of the magnetic core 5. In an embodiment, the first component 1 and the second component 2 have the same volume and size, and each of the first component 1 and the second component 2 occupies 50% of the volume of the magnetic core. In another embodiment, each of the volumes of the first component 1 and the second component 2 may have a tolerance within 10%. That is, the first component 1 or the second component 2 may occupy 40% to 60% of the volume of the magnetic core 5. The flexible material 3 is disposed on the inner surface 11 of the first component 1 and the inner surface 21 of the second component 2 respectively. The flexible material 3 has deformable property. The flexible material 3 can be selected according to the characteristics of softness and elasticity, which relate to the expansion characteristics of the thermal conduction glue, the flexible material 3 is for example but not limited to a margin tape or a non-woven tape. The coil 4 is sleeved on both of the first component 1 and the second component 2. The coil 4 is for example but not limited to an edgewise coil with a prefabricated flat wire, or a round wire. In an embodiment, the winding track of the coil 4 matches the outer contour of the cross-section of the connecting surface, in other words, the cross-section of the magnetic core 5 taken along the cross-section XX. The winding track of the coil 4 is for example but not limited to a circle, a square or an ellipse. When the coil 4 is sleeved on the first component 1 and the second component 2, the two connecting surfaces 10 of the first component 1 are connected to the two connecting surfaces 20 of the second component 2 respectively, so the first component 1 and the second component 2 are assembled to each other to form the magnetic core 5, and the magnetic core 5 and the coil 4 form a magnetic element 100. The method of assembling the first component 1 and the second component 2 is for example but not limited to glue bonding.

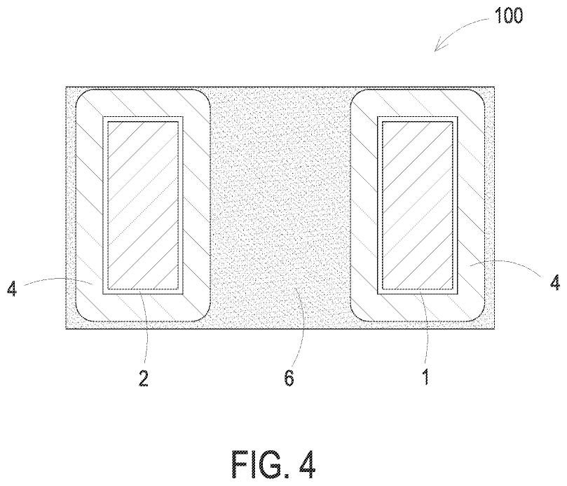

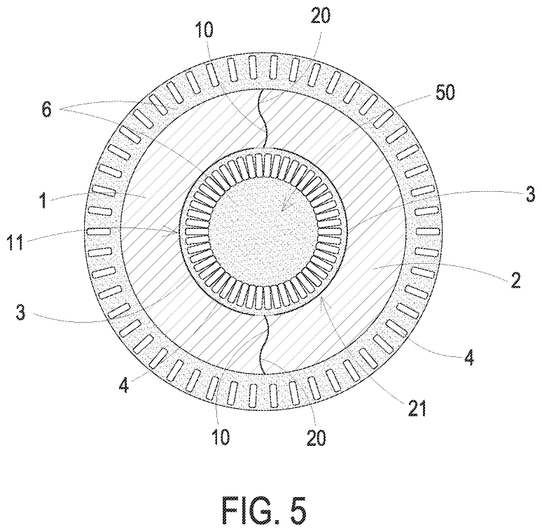

FIG. 4 is a schematic cross-sectional view illustrating the magnetic element of FIG. 1 after potting with the thermal conduction glue and taken along the cross-section XX. FIG. 5 is a schematic cross-sectional view illustrating the magnetic element of FIG. 1 after potting with the thermal conduction glue and taken along the cross-section YY. The section directions of the cross-sections XX and YY of the magnetic element are shown in FIG. 3. As shown in FIGS. 4 and 5, the magnetic element 100 is potted with the thermal conduction glue 6, the material of the thermal conduction glue 6 is for example but not limited to thermal conduction silicon. After the magnetic element 100 is potted with the thermal conduction glue 6, the flexible material 3 is located between the inner surfaces 11 and 21 and the thermal conduction glue 6 within the hollow 50. It should be noted that, in the embodiment shown in FIGS. 4 and 5, the thermal conduction glue 6 completely covers the magnetic element 100, but the covering degree is not limited to this. For example, one third of the magnetic element 100 may be in contact with the thermal conduction glue to achieve the requirement of the thermal conductivity.

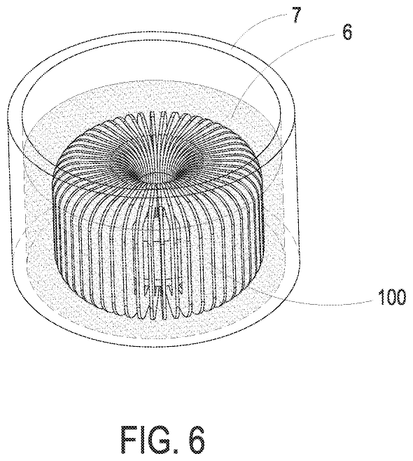

In an embodiment, the magnetic element 100 may be disposed in a device, the thermal conduction glue 6 is injected into the device, thus the magnetic element 100 is potted with glue. As shown in FIG. 6, the magnetic element 100 is disposed in a device 7 filled with the thermal conduction glue 6, and the magnetic element 100 in the device 7 is potted with thermal conduction glue. It should be noted that the device is for example but not limited to an inductor housing or a device in which the inductor is assembled, and the shape of the device is not limited to the cylindrical shape shown in FIG. 6, but can also be a cube shape, or a shape adapted to the magnetic element.

In the present disclosure, the magnetic core is divided into two components, and before the two components are assembled to form a magnetic element, a flexible material with deformable property is disposed on the inner surface of each component individually. Therefore, the thermal conduction glue between the coil and the magnetic core expands under the operation of the magnetic component due to the heating of the coil and core and dilate the magnetic core. the flexible material disposed on each component may buffer the deformation of the thermal conduction glue and absorb the expansion force on the magnetic core due to the thermal conduction glue, so as to avoid the potential cracking of the two assembled components due to the deformation of the thermal conduction glue. In addition, there is no need to set additional metal ties or divide the magnetic core into two parts with different sizes during manufacturing, the loss of coil space utilization caused by the metal tie buckle or the process of cutting small pieces of magnetic core is avoided, and the problem of losing the amount of the coil turns while the coil cannot be disposed in the breach formed by the part of the magnetic core with small size or the metal tie buckle is avoided. Therefore, the coil filling rate of the magnetic element is improved, thus the inductance of the magnetic element is improved. Meanwhile the magnetic element is more suitable for automated production, thus the production efficiency is improved due to the saving of human labor force in the production process.

It should be noted that, in the embodiment shown in FIGS. 2 and 3, in order to ensure sufficient absorption of the expansion force to the magnetic core generated by the thermal expansion of the thermal conduction glue during the operation state of the magnetic element, the flexible material 3 may completely cover the inner surfaces 11 and 21 of the first component 1 and the second component 2 respectively, but the degree of coverage is not limited to this. In an embodiment, due to different expansion characteristics of the thermal conduction glue, the surface area of the flexible material 3 occupies at least one third of the inner surfaces 11 and 21 of the first and second components 1 and 2, respectively. The thickness of the flexible material 3 is adjustable according to the expansion force required to be absorbed.

The way of assembling the first component 1 and the second component 2 is not limited. For example, an adhesive may be adhered to the connecting surfaces 10 and 20 of the first component 1 and the second component 2 respectively, so that the connecting surfaces 10 and 20 of the first component 1 and the second component 2 are connected to each other by the adhesive. The adhesive is for example but not limited to an epoxy glue.

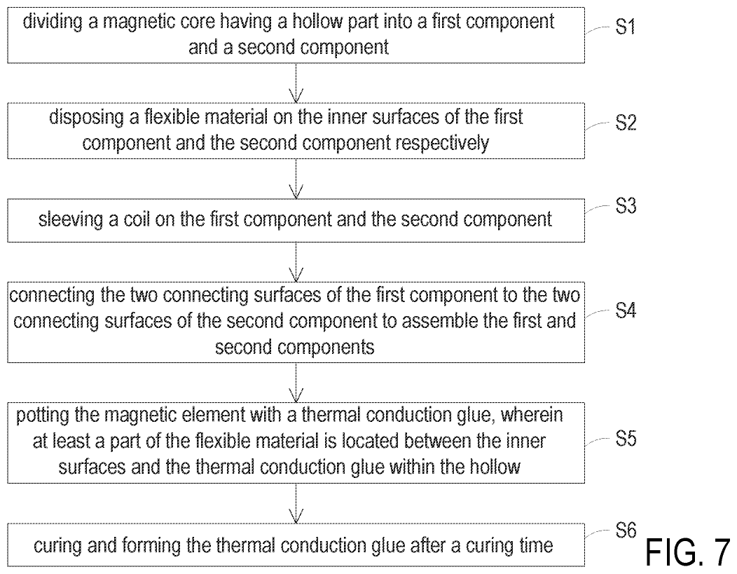

FIG. 7 is a schematic flow chart illustrating a manufacturing method of the magnetic element according to an embodiment of the present disclosure. The manufacturing method of the magnetic element of the present disclosure is applicable for the magnetic element 100 stated above. Please refer to FIG. 7, the manufacturing method of the magnetic element of the present disclosure includes steps S1, S2, S3, S4, S5 and S6. In step S1, a magnetic core 5 having a hollow part 50 is divided into a first component 1 and a second component 2, wherein the first component 1 has two connecting surfaces 10 of the split section, and the second component 2 has two connecting surfaces 20 of the split section along with the cross-section XX. The first component 1 has an inner surface 11 and an outer surface 12 relative to a center of the magnetic core 5. The second component 2 has an inner surface 21 and an outer surface 22 relative to a center of the magnetic core 5. In step S2, a flexible material 3 is disposed on the inner surfaces 11 and 21 of the first component 1 and the second component 2 respectively, wherein the flexible material 3 has deformable property. In step S3, a coil 4 is sleeved on both of the first component 1 and the second component 2. In step S4, the first component 1 and the second component 2 are assembled by connecting the two connecting surfaces 10 of the first component 1 and the two connecting surfaces 20 of the second component 2, wherein the magnetic core 5 and the coil 4 form a magnetic element 100. In step S5, the magnetic element 100 is potted with a thermal conduction glue, wherein at least a part of the flexible material 3 is located between the inner surfaces 11 and 21 and the thermal conduction glue 6 within the hollow 50. In step S6, the thermal conduction glue 6 is cured and formed after a curing time.

From the above descriptions, the present disclosure provides a magnetic element and a manufacturing method thereof. The magnetic core is divided into two components, and before the two components are assembled to form a magnetic element, a flexible material with deformable property is disposed on the inner surface of each component. Therefore, during the operation of the potting magnetic element, when the thermal conduction glue between the coil and the magnetic core expands due to the heating generated by the coil and core thus dilate the magnetic core, the flexible material can buffer the deformation of the thermal conduction glue and absorb the expansion force from the thermal conduction glue applied to the magnetic core, so as to avoid the deformation of the thermal conduction glue from affecting the connection of the two components. Therefore, the magnetic core can be fully utilized, so that the coil filling rate and inductance of the magnetic element are improved, and automatic production is facilitated, manpower labor force is saved, and production efficiency is improved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method of a magnetic element comprising steps of:
(a) dividing a magnetic core having a hollow part into a first component and a second component, wherein each of the first component and the second component has two connecting surfaces of the split section, and each of the first component and the second component has an inner surface and an outer surface relative to a center of the magnetic core;
(b) disposing a flexible material on each inner surface of the first component and the second component individually, wherein the flexible material has deformable property;
(c) sleeving a coil on the first component and the second component;
(d) connecting the two connecting surfaces of the first component to the two connecting surfaces of the second component respectively to assemble the first and second components, wherein the magnetic core and the coil form the magnetic element;
(e) potting the magnetic element with a thermal conduction glue, wherein at least a part of the flexible material is located between both of the inner surfaces of the first component and the second component and the thermal conduction glue within the hollow; and
(f) curing and forming the thermal conduction glue after a curing time.

2. The manufacturing method according to claim 1, wherein at least one third of the magnetic element is in contact with the thermal conduction glue.

3. The manufacturing method according to claim 1, wherein the flexible material covers each inner surface of the first component and the second component individually, and a surface area of the flexible material occupies at least one third of each inner surface of the first component and the second component.

4. The manufacturing method according to claim 1, wherein the flexible material is a non-woven tape.

5. The manufacturing method according to claim 1, wherein the coil is an edgewise coil with prefabricated flat wire.

6. The manufacturing method according to claim 1, wherein a winding track of the coil matches an outer contour of a cross-section of the magnetic core.

7. The manufacturing method according to claim 1, wherein the thermal conduction glue is potted in a device accommodating the magnetic element.

8. The manufacturing method according to claim 1, wherein a volume of each of the first component and the second component occupy 50% of a volume of the magnetic core.

9. The manufacturing method according to claim 1, wherein the material of the thermal conduction glue is a thermal conduction silicon.

10. The manufacturing method according to claim 1, wherein the magnetic core is a toroidal magnetic core.

11. The manufacturing method according to claim 1, wherein in the step (d), an adhesive is adhered to the two connecting surfaces of each of the first component and the second component, the first component and the second component are connected to each other by the adhesive.

12. The manufacturing method according to claim 11, wherein the adhesive is an epoxy adhesive.

13. A magnetic element, comprising:
a first component and a second component, wherein the first component and the second component form a magnetic core with a hollow, each of the first component and the second component has two connecting surfaces on the split section, and each of the first component and the second component has an inner surface and an outer surface relative to a center of the magnetic core;
a flexible material disposed on each inner surface of the first component and the second component individually, wherein the flexible material has deformable property; and
a coil sleeved on both of the first component and the second component,
wherein the two connecting surfaces of the first component are connected to the two connecting surfaces of the second component respectively to assemble the first and second components, wherein the magnetic element is potted with a thermal conduction glue, wherein the flexible material is located between both of the inner surfaces of the first component and the second component and the thermal conduction glue within the hollow.

14. The magnetic element according to claim 13, wherein a material of the thermal conduction glue is a thermal conduction silicon.

15. The magnetic element according to claim 13, wherein the flexible material covers each inner surface of the first component and the second component individually, and a surface area of the flexible material occupies at least one third of each inner surface of the first component and the second component.

16. The magnetic element according to claim 13, wherein the flexible material is a non-woven tape.

17. The magnetic element according to claim 13, wherein the coil is an edgewise coil with prefabricated flat wire.

18. The magnetic element according to claim 13, wherein a volume of each of the first component and the second component occupy 50% of a volume of the magnetic core.

19. The magnetic element according to claim 13, wherein the thermal conduction glue is potted in a device filled with the magnetic element.

20. The magnetic element according to claim 13, wherein an adhesive is adhered to the connecting two surfaces of each of the first component and the second component, the first component and the second component are connected to each other by the adhesive, and the adhesive is an epoxy adhesive.
